(19) United States
(12) Patent Application Publication
(10) Pub. No.: US 2018/0019960 A1
(43) Pub. Date: Jan. 18, 2018

(54) Communicating Between Applications

(71) Applicant: Microsoft Technology Licensing, LLC, Redmond, WA (US)

(72) Inventors: Massimo Perga, Wokingham (GB); Rupsha Mazumdar, London (GB)

(73) Assignee: Microsoft Technology Licensing, LLC, Redmond, WA (US)

(21) Appl. No.: 15/270,979

(22) Filed: Sep. 20, 2016

(30) Foreign Application Priority Data
Jul. 14, 2016 (GB) 1612256.6

(51) Int. Cl. H04L 12/58; H04L 29/06; H04M 7/00

(52) U.S. Cl. CPC H04L 51/046; H04M 7/006; H04L 51/04; H04L 63/0428; H04L 67/42

(57) ABSTRACT

A method comprising: (a) sending a signal from a first to a second application, specifying a request initiated by a first user for a predetermined action to be performed by the second application, the first signal including at least a conversation identification recognized by the first application as identifying a communication session between a group of users; (b) once the second application has performed the action, receiving back a second signal at the first application from the second application, comprising an asset provided by the second application as a result of the predetermined action, or a link to this asset, and further comprising a return of the conversation identification; and (c) based on the returned conversation identification, providing the asset or the link to the asset to one or more other users in the group via said communication session conducted through the first application.

### PRIORITY

This application claims priority under 35 USC 119 or 365 to Great Britain Application No. 1612256.6 filed Jul. 14, 2016, the disclosure of which is hereby incorporated by reference in its entirety.

### BACKGROUND

A uniform resource indicator (URI) is a string of characters used to identify a resource such as an application. Thus, amongst other uses, URIs enable a first application to initiate an action by a second application. To do this, the first application invokes the URI via the operating system on which the first application is running, i.e. by indicating the URI in a request to the operating system so that in response the operating system calls upon the second application. The second application may be running on the same instance of the operating system on the same user terminal as the first application, or alternatively may be run on a remote terminal in which case the URI causes it to be contacted via a suitable network such as the Internet.

A URI comprises a left-most portion called the “scheme” which identifies the resource, in this case the application. Optionally the URI also comprises one or more further portions which qualify the action to be taken in response to the URI. An example is the “mailto” URI scheme which when invoked by, say, a web browser, calls upon an email client in order to open a new email. For instance, invoking the following URI would open a new email to a user Dave Example whose email address is dave@example.com.

mailto:dave@example.com

A URI can be associated with a particular application. When a new application is first installed on a given user terminal, it can register its URI scheme with a list of custom URI schemes recognized by the operating system on that terminal. Another application can then initiate an action by that application by invoking a URI comprising the registered URI scheme. For example, say a company called Acme runs an internet-based communication service and provides a corresponding communication client application for conducting communications such as VoIP calls and/or instance messaging (IM) via said service. Say also that this company is allocated the URI scheme “acme”. When the communication client is installed it registers the URI acme with the operating system's list of custom URI schemes. Another application can then launch the communication client by invoking the following URI.

acme:

Or if Dave's username within the communication system is dave_example, the other application can then initiate a default action in relation to Dave, e.g. a voice over IP (VoIP) call, by invoking the following URI.

acme:dave_example

A mobile deep link is a URI that links to a specific function within an application, rather than simply launching an application generally. Examples would be as follows.

acme:dave_example?chat initiates an IM chat session with Dave

acme:dave_example?call&video=true initiates a video call with Dave

acme:dave_example?profile views Dave's profile

The term “mobile deep links” refers to the use of such links in the context of one or both of the applications being a mobile applications run on a mobile terminal (whether the same mobile terminal or different ones), but a similar mechanism can also be used by applications run on one or more static terminals, or to implement interactions between mobile and static terminals.

A uniform resource locator (URL) is a URI that, as well as identifying a resource, specifies a particular means of acting in relation to it. An example of a URL scheme is http, which specifies that communications with the resource resulting from invocation of the URL shall be conducted according to Hypertext Transfer Protocol (HTTP). Another example of a URL scheme is https, which specifies that communications with the resource resulting from invocation of the URL shall be conducted according to the HTTPS (HTTP Secure) protocol. In the latter case, the application being linked to is authenticated before communications can proceed, and when they do, the communicated data is encrypted according to a cryptographic standard such as TLS (Transport Layer Security) or SSL (Secure Socket Layer).

If a first application links to a second application via a URL in the form of an HTTP or HTTPS link, an advantage of this is that it provides a web fall-back in case the second application is not available locally on the same terminal as the first application. When the URL is invoked the operating system checks whether it has the respective URL scheme in its register of custom URI schemes. If so, it calls upon the local instance of the application installed on the same terminal as the first application to perform the desired action. If not however, it either downloads an instance of the second application from the web or calls upon a web-hosted version of the second application in order to perform the action in question (optionally after prompting the user with an option to do one of these). An example would be:

https://call.acme.com/dave_example

The first application invokes this URL in order to initiate a voice call (e.g. VoIP) with Dave Example via the Acme communication service. In response the operating system checks whether the there is a locally installed instance of the Acme client. If so, the operating system launches the local acme client (or switches to it if already running in a background state) and passes it at least an indication of the requested action (in this case a call) and the target of the action (the username “dave_example”). In turn the local instance of the Acme client sends a call establishment request to the remote instance of the Acme client running on the Dave's user terminal and, if Dave accepts, proceeds to conduct the call.

If, however the operating system finds, when the URL is invoked, that there is no local instance of the Acme client installed locally on the same user terminal as the first application and the operating system, then the operating system instead uses the URL to contact the Acme server to either download an instance of the Acme client (and then proceed as outlined above), or to send the call establishment request and conduct the call via a web-hosted version of the Acme client. The user may be prompted before doing this.

Another known mechanism is for a URI to contain a return URI. That is, a first application invokes a URI to a second application, wherein that URI itself contains a further, embedded URI which specifies the first application as the destination resource of the embedded URI. For instance, in the case where the second application is a communication client such as a VoIP and/or IM client, a known use of this is for the first application to retrieve a conversation history of past communications conducted through the communication client.

### SUMMARY

Some communication client applications such as IM and VoIP applications presently have no mechanism in place to create a calendar event containing, for instance, an invitation to a group voice call or IM session. The inventors of the present invention have recognized that there is scope to use a URI with an embedded return URI—or similar—to enable a communication client like a VoIP or IM application to call to a calendar application such as an email client with calendar function, and to thereby provide the functionality to create calendar events. Particularly, by providing the calendar application with a conversation ID which the calendar application then returns to the VoIP or IM application (e.g. by means of a call-back URI in a mobile deep link), the calendar event can be inserted into a conversation conducted through the VoIP or IM service, thus enabling the VoIP or IM service to be used as an alternative transport mechanism to share the invitation to all of the participants to a certain conversation. More generally, a similar mechanism can be used to allow the VoIP, IM or other such communication client application to fetch other content from a second application and distributed it though a conversation.

According to one aspect disclosed herein there is provided a method of interacting between a first application and a second application. The first application is a communication client for using a communication service to conduct a communication session over a network between a group of users comprising a first user and one or more other users (e.g. a VoIP and/or IM client for conducting a VoIP call and/or IM session). In embodiments the second application may be an application comprising a calendar function, such an email client). The method comprises: (a) sending a signal from the first application to the second application, specifying a request initiated by the first user for a predetermined action to be performed by the second application (e.g. for a calendar event to be created), said first signal including at least a conversation identification recognized by the first application as identifying the communication session between said group of users; (b) once the second application has performed said predetermined action, receiving back a second signal at the first application from the second application, the second signal comprising an asset (e.g. calendar event) provided by the second application as a result of said predetermined action, or a link to said asset, and further comprising a return of the conversation identification; and (c) based on the returned conversation identification, providing the asset or the link to the asset to the one or more other users via said communication session conducted through the first application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put in effect, reference is made by way of example to the accompanying drawings in which:

FIG. 1 is a schematic block diagram of a communication system,

FIG. 2 is a schematic illustration of a process of creating a calendar event, and

FIG. 3 is a schematic mock-up of a user interface.

### DETAILED DESCRIPTION OF EMBODIMENTS

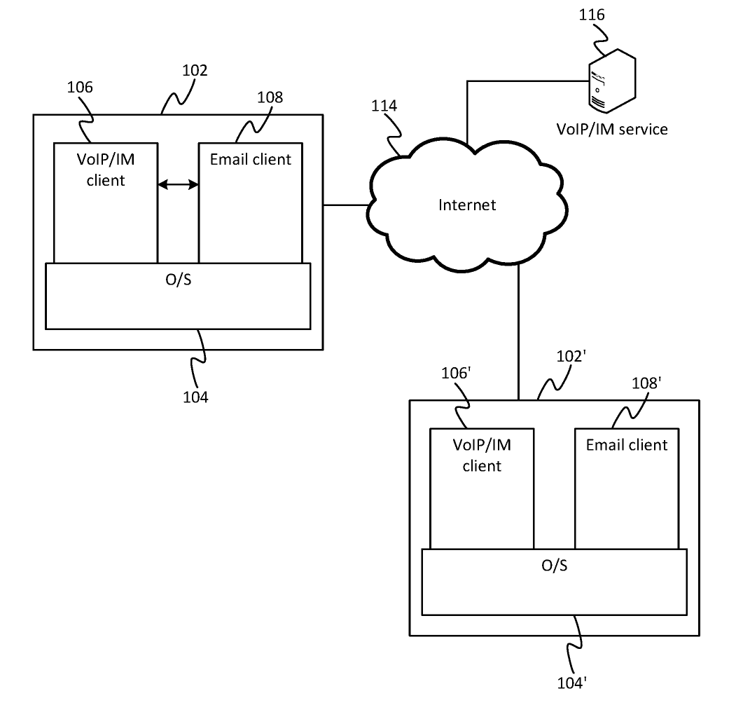

FIG. 1 illustrates an example communication system in accordance with embodiments of the present disclosure.

The system comprises a first user terminal 102 configured to connect to a network 114. The first user terminal 102 may take any of a variety of forms, e.g. a desktop computer; or a portable user terminal such as a laptop, tablet, smartphone, smartwatch or smart-glasses; a console of a vehicle such as an in-car console. The system also comprises one or more other user terminals 102′, each of which may also take any such form (and the various user terminals 102, 102′ need not necessarily take the same form).

The network 114 preferably takes the form of a wide are internetwork such as that commonly referred to as the Internet. The user terminal 102 may be configured to connect to the Internet 114 via any suitable means: the user terminal 102 may comprise a wired interface configured to connect to the network 114 via a wired connection, e.g. via a landline or wired local area network such as a local Ethernet network; or more preferably the user terminal 102 may comprise a wireless interface configured to connect to the Internet 114 via a wireless connection, e.g. via a wireless access point, wireless home router, wireless local area network (WLAN), or wireless cellular network such as a 3GPP based network. For instance, the wireless interface may operate according to any local (short range) radio frequency (RF) technology such as Wi-Fi or Bluetooth. Any of the external communications discussed herein may be implemented any of the above-mentioned communications means and/or others, and for brevity the different possibilities will not be repeated each time. Note also that each of the one or more other user terminals 102′ may also comprise any of the above types of communication interface for performing their respective communications.

The first user terminal 102 is installed with an operating system 104, a first application 106, and a second application 108. That is, each of these is stored on a memory of the first user terminal 102 (comprising one or more memory units, e.g. magnetic and/or electronic memory units) and is arranged to run on a processor of the first user terminal 102 (comprising one or more processing units, e.g. one or more cores or one or more separate processing chips).

In embodiments, the first application 106 may take the form of a communication client application such as a VoIP and/or IM client (“VoIP/IM client” for short). By means of the communication client application 106 running on the user terminal 102, this thereby enables the user of the user terminal 102 to conduct inter-user communication sessions such as VoIP calls and/or IM conversations with one or more of the other user terminals 102′, via the Internet 114, using a communication service provided by a communications service provider. In embodiments the service is provided at least in part by a server 116 operated by the communications service provider. The inter-user communications (e.g. VoIP calls and/or IM messages) may be relayed via a server 116 operated by the provider of the communications service, or alternatively a peer-to-peer (P2P) topology may be used. Even if the communications themselves are not relayed via the server 116, the server 116 may still be arranged to provide supplementary functionality of the communication service, such as storing contact lists, presence information and/or profile information; and/or issuing authentication certificates to users so that the users can provide their identity to one another.

The second application 108 may take the form of a calendar application, e.g. an email client with integrated calendar functionality. By means of the communication client application 106 running on the user terminal 102, this thereby enables the user of the user terminal 102 to send emails to one or more of the other user terminals 102 via the internet 104.

The one or more other user terminals 102′ are each also installed with a respective operating system 104′, a respective VoIP/IM client 106′ and a respective calendar application 108′ (e.g. email client). These allow the users of the one or more other user terminals to participate in VoIP calls and/or IM sessions and to send emails in a similar manner as discussed in relation to the first user terminal 102.

There is a problem with existing VoIP and IM clients 106 in that they have no mechanism to create a calendar event containing, for instance, an invitation to a group voice call. To address this, the present disclosure provides a mechanism to enable a VoIP and/or IM client 106 to interact with a calendar application such as an email client 108, so that the VoIP/IM client 106 can set up a calendar event, such as to schedule a call to be conducted through the VoIP service. Further, in embodiments, in the case where the calendar application 108 takes the form of an email client with calendar functionality, then the email client 108 can also be used to supply e-mail transport to share the calendar event. At the very same time, the VoIP/IM client 106, 106′ and VoIP/IM service can be used as an alternative transport mechanism to share the invitation to all of the participant to a certain conversation. In some embodiments, this also enables contacts for whom the e-mail address or the VoIP/IM service username is known to be invited to share the same experience.

In embodiments, this mechanism can be implemented using a mobile deep link in the following way. The VoIP/IM client 106 is configured to send a URI to the calendar application 108 invoking it to create a calendar event, and sending it an identification of a conversation (a “conversation identification”), which may either take the form of a conversation ID code or a list of conversation participants which should receive the calendar event. The URI also contains a return URI linking back to the VoIP/IM application 106, invoking the calendar application 108 to send back the content of an iCalendar event supporting RFC5545 standard, and also to return the conversation ID or the list of the conversation participants. The VoIP/IM client 106 is configured to receive these pieces of information back from the calendar application 108 and parse the content supplied, and—if the content is compliant with the standard—the VoIP/IM client will generate locally a .ics file representing the iCalendar event. Alternatively, the event content is sent back from the email client 108 in the form of a .ics file, in which case the VoIP/IM client 106 application will simply receive it as any other file and can then share it to other conversation participants (i.e. the VoIP/IM client does not need to generate the .ics file itself).

Thus it is possible to create a file representing a calendar event from within a certain conversation. The .ics file so generated will be sent to the conversation corresponding to the conversation ID or to the list of the conversation participants. The VoIP/IM clients 106′ of the participants, upon receiving the .ics file, will present this as a regular file transfer. But, when the receiving users have agreed to download the file and the file transfer has succeeded, the content of the .ics file will be parsed and its contents displayed in a friendly way. Upon selecting the .ics file, e.g. clicking it, this will add the calendar invite to the default calendar application on the invited user's device 102′.

This mechanism allows the VoIP/IM client 106 to accept standard iCalendar contents or accept .ics files from any calendar applications 108 with mobile deep linking capabilities to create a seamless calendar experience within the VoIP/IM client 106. In some embodiments, it also enables VoIP/IM-related calendar features, such as a meeting invite scheduling a VoIP call, to be made available to contacts for whom either the e-mail address (supplied by the email client 108) or the username within the VoIP/IM service is not known.

RFC5545, the IETF standard for the ICS (iCalendar) files, supports the concept of a unique identifier for identifying a calendar event, which can be used by the calendar application 108 when determining whether the event is a duplicate. This parameter is named “UID” and it can be found at section “3.8.4.7. Unique Identifier” of RFC5545. Therefore, by using this, in embodiments it is possible to avoid duplication in the calendar for users both being invited using a calendar application and .ics file transfer via the VoIP/IM service.

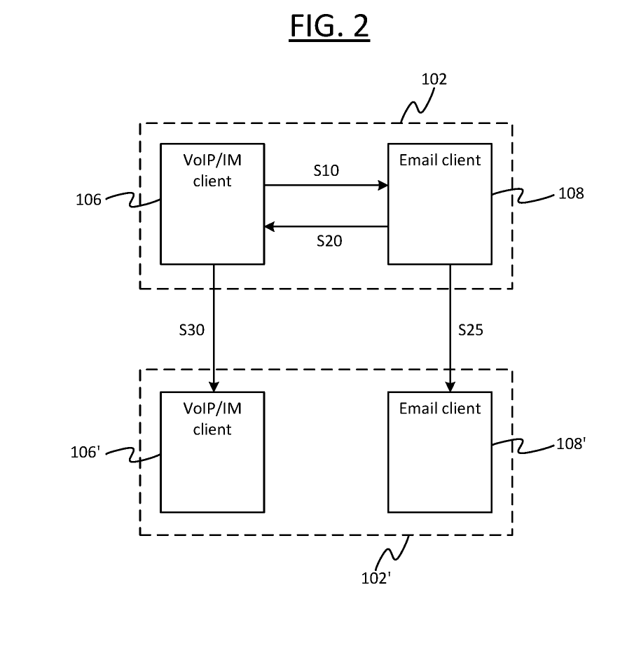

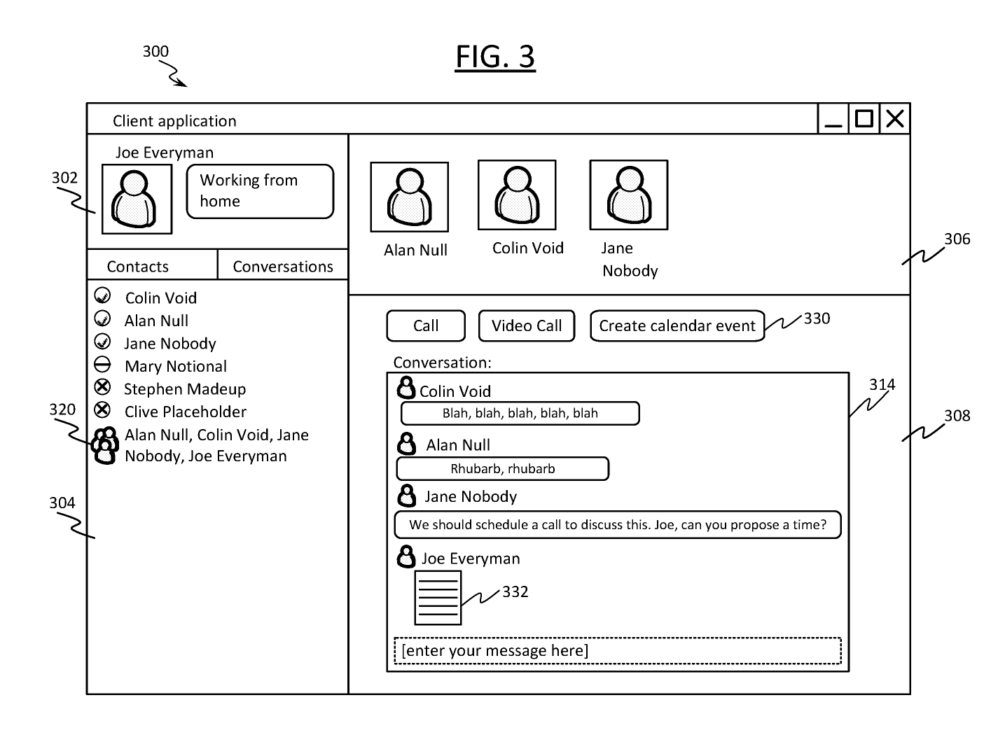

An example process flow in accordance with embodiments disclosed herein is now discussed with reference to FIGS. 2 and 3. The following will be described in terms the second application 108 being an email client with calendar functionality, but it will be appreciated that (except in embodiments where is sends an email) the second application could be any type of calendar application.

FIG. 3 illustrates an example user interface (UI) 300 of the VoIP/IM client application 106, which is displayed to the user of the first user terminal 102. A similar user interface is presented to the one or more other users by the VoIP/IM clients on their respective user terminals 102′. The user interface 300 comprises a plurality of sections or “panes”. E.g. these may comprise one or more of: (a) a self-information pane 302 displaying a selection information from the user's own profile (e.g. given name, profile picture and/or mood message); (b) a contacts list pane 304 displaying some or all of the other user's in the user's contact list, and which may also display an indication 320 of group of contacts selected to be participants in a given conversation; (c) a participants pane 306 which shows an indication of the users in the current conversation; and (d) a conversation pane 308 where the actual content of the conversation is displayed.

To instigate the process of creating and distributing a calendar event, first a conversation is defined. In embodiments, a given conversation is defined at least by a particular group of participants (i.e. a particular group of selected ones of the users participating in a communication session together). The group of participants may be selected by the first user or one of the one or more other users (participants) in the conversation. Once this is done, the VoIP/IM clients 106, 106′ and the communication service provided by the server 116 work together to enable the participants to conduct a conversation via the Internet 116. The conversation may comprise IM messages, one or more VoIP calls (which may comprise voice or video calls), and/or one or more file transfers. The content of the conversation, or an indication thereof, is displayed to each of the participants in the conversation pane 308 of the VoIP/IM client 106 running on his/her respective user terminal 102, 102′. For instance, in the case of IM messages, the content of these is displayed in chronological order in the conversation pane 308; and in the case of VoIP calls, a record of these (e.g. recording the time and length of the call) may be displayed in the conversation pane 308, e.g. interleaved amongst the IM messages in chronological order relative to the IM messages. In the case of a file transfer, an indication such as an icon may be inserted into the conversation as shown in the conversation pane 308 (e.g. again in chronological order amongst the IM messages and any call records), wherein the user can select the icon or other such indication (e.g. by clicking or touching it) in order to retrieve the file. In embodiments this may also automatically open the file.

In embodiments, a conversation may additionally be defined or at least qualified by one or more additional pieces of information, e.g. a title or subject line. In particular embodiments, a conversation ID (i.e. an identification code such as a numerical code) is assigned to the conversation, e.g. being assigned by the client 106, 106′ that created the conversation or by the server 116. This ID is then mapped to the list of participants of the conversation. The mapping may be stored at, and accessed from, one or more of the user terminals 102, 102′ and/or the server 116.

Once a conversation has been created, then at some point in the conversation the first user selects to create a calendar event to share with all of the other participants (the invitees). To enable this a UI control 330 may be included in the user interface 300 of the VoIP/IM client 106. The UI control may comprise additional options (not illustrated) to enable the first user to specify additional parameters of the calendar event (in addition to the participants), e.g. one or more of: (i) a type of the event (e.g. VoIP call or in-person meeting), (ii) a date or date range of the event, (iii) a start time at which the event is to start, (iv) a finish time at which the event is planned to finish, (v) a location at which the event is to be held, (vi) a title of the event, and/or (vii) a text description of the event.

Referring to FIG. 2, at step S10 the VoIP/IM client 106 of the first user formulates a first URI, e.g. in the form of a mobile deep link, which will cause the email client 108 to create a calendar event (N.B. this being the email client 108 on the same user terminal 102, i.e. the first user's terminal). The first URI comprises at least: an identification of the conversation (which could be in the form of the conversation ID or a list of the participants), and a return URI (or “call-back” URI) calling back to the VoIP/IM client 106. The first URI also comprises one or more additional parameters of event to be created, including at least an indication of a time and/or date of the event. For example, the one or more additional parameters may comprise any one or more of items (i) to (vii) mentioned above. When the first URI is invoked by the VoIP/IM client 106, this causes the identification of the conversation, the return URI and the one or more additional parameters to be supplied to the email client 108. I.e. it supplies the information to define the event. It also causes the email client 108 to formulate a meeting invite based on the supplied meeting parameters. In embodiments the email client 108 may formulate the invite in a RFC5545 compliant format.

Furthermore, as represented by step S20, the invocation of the first URI by the VoIP/IM client 106 also causes the email client 108 to invoke the return (call-back) URI. When the email client 108 invokes the return URI, this causes the email client 108 to send the event invite it has just created back to the VoIP/IM client 106, e.g. in the RFC5545 compliant form. The returned information also includes the identification of the conversation (conversation ID or participant list) which the email client 108 received from the VoIP/IM client 106 as a result of the first URI. I.e. the email client 108 repeats or “parrots back” the conversation identification which it received from the VoIP/email client, in embodiments in the same form in which it was originally received from the VoIP/IM client 106.

Say the VoIP/IM service is called “Acme” and has a custom URI scheme “acme”. According to embodiments disclosed herein, the VoIP/IM client application 106 is modified such that another application running on the user terminal 102 can then cause the VoIP/IM client 106 to create a calendar event by invoking a URI of the form:

acme:<list of participants>?calendar=<content of the iCalendar event supporting RFC5545 standard>

or as an HTTPS-based URI of the form:

https://calendar.skype.com/<conversation ID>?calendar=<content of the iCalendar event supporting RFC5545 standard>

Say also the email client is provided by a company called “WhizzoSoft” who provides an email client called “Lookout”, and this and has an associated URI scheme “ws-lookout”. In order to have the email client 108 and the VoIP/IM client 106 cooperating to achieve the above-described scenario, the x-callback-uri technique may be used in the following way:

ws-lookout://x-callback-uri/create-

event?title=Hello&location=Seattle&description=This%20is%20some%20description
&startTime=2016-11-04T09:20:22+00:00&endTime=2016-11-
05T10:20:22+00:00&invitees=hello@example.com,somebody@example.com&x-
source=acme&x-success:acme%3A%2F%2F<list of
participants>%3Fcalendar%3D<content of the iCalendar event supporting RFC5545
standard>

Invoking the above URI at the VoIP/IM client 106 will initiate the interaction between the VoIP/IM application 106 and the email client 108 as represented by steps S10 and S20.

Note that in the above examples, a number of variants are possible. For example, the <content of the iCalendar event supporting RFC5545 standard> may be replaced by the .ics file itself I.e. the email client returns the event already in the form of a .ics file.

Alternatively, or additionally, as will be described in more detail later, the URI invoked by the VoIP/IM client 106 does not necessarily have to include any of the event information other than the conversation ID. E.g. it need not include an explicit list of the participants, as these may be resolved by the email client 108 based on the conversation ID and an integration with the VoIP/IM service. And/or, the outgoing URI need not include any other event information such as time and/or location. Instead, in embodiments, the mechanism, exploits the user interface (UI) of the email client (or more generally calendar application) 108 to allow the user to input some or all of this information. That is, the VoIP/IM client 106 need not pass any information to the email client 108 at first. Instead it will invoke it with just a conversation ID and a callback URI. The email client 108 will then appear on the user's screen and provide the UI to fill in the event details and then click send to send the invite to the participants that it can resolve from the conversation ID.

At step S30, the invoking of the return URI by the email client 108 also causes the VoIP/IM client 106 to insert the returned meeting invite into the conversation identified by the conversation identification repeated (“parroted”) back by the email client 108. I.e. because the email client 108 sends back the same conversation identification information that it originally received from the VoIP/IM client 106 when the first URI was invoked, then the VoIP/IM client now knows what conversation to insert the supplied event invite into. In embodiments, the VoIP/IM client 106 is configured to generate a .ics file from the RFC5545 compliant data it receives from the email client 108, and inserts the event invite into the conversation in the form of this .ics file. Alternatively, the VoIP/IM does not need to generate the .ics file itself, and instead simply receives the event back from the email client 108 already in the form of the .ics file.

By inserting the event invite (e.g. the .ics file) into the conversation, this causes the invite to be distributed to all the participants of the conversation, to their respective user terminals 102′ over the internet, by means of the communication service provided by the VoIP/IM provider. In embodiments, the event invite may be inserted into the conversation in the form of a file transfer, and may appear in the conversation in the form of an on-screen indication such as an icon 332 which each of the receiving participants can select to retrieve, e.g. by clicking or touching the icon 332 or other such indication. When the receiving participant does so, the calendar event (e.g. meeting) is added to that person's default calendar application. Note also that the meeting or other event to which the invitee is invited does not have to be the same session as the conversation through which the invite is received. For example, the invite may be delivered through a file transfer as part of an IM conversation, but may be an invite to a VoIP conference call.

The above mechanism advantageously enables the calendar functionality from a second application 108 to be seamlessly integrated with a first application 106, and furthermore for an additional distribution channel to be provided for distributing the event invite, i.e. through the communication service used by the VoIP/IM clients 106, 106′ rather than just, say, email as may be used by the calendar application 108.

In embodiments, the disclosed mechanism is also advantageous because the VoIP/IM client 106 may not have any information to setup an invite except for the participants in a conversation, or at least may not have all the information. E.g. the VoIP/IM client 106 may lack the user interface elements required to enable the user to input information such as meeting time and location. E.g. the UI of the VoIP/IM application may lack a date and time picker, a meeting room booker or a scheduling assistant, which the email client (or calendar application) 108 may have. Hence in embodiments, the URI involved by the VoIP/IM client 106 may leave some of the meeting invitation information to be inserted by the email client (or more generally calendar application). Between steps S10 and S10 the email client 108 (or calendar application) may prompt the user via its user interface to enter details such as event time and/or event location. When it invokes the call-back URI, the email client or calendar application 108 then inserts the entered information into the message (e.g. the RFC5545 data) sent back to the VoIP/IM client 106, so the VoIP/IM client 106 can send an invite including this information to the participants of its conversation (e.g. in .ics form).

As an optional step S25, the email client 108 may also send an email version of the invite to the one or more invitees, via the internet 116 but by email rather than via the VoIP/IM provider's service. This advantageously doubles the opportunities (number of channels) via which to disseminate event invite. In such embodiments, preferably an identifier uniquely identifying the event invite amongst all other possible event invites—e.g. the RFC5545 UID—is included in both the email version of the invite and the version distributed via the VoIP/IM clients 106, 106′ (e.g. the .ics file). This way if one of the invitees receives the invite to the same event via both channels (via both email and the VoIP/IM provider's service), and selects the invite (e.g. clicks .ics file) so as to launch the default calendar application on the invitee user's terminal 102′, then this calendar application does not duplicate the calendar event in the invitee's calendar. Note also that step S25 does not need to be performed in any particular order compared to Steps S20 and S30.

Note also that in embodiments, when the conversation identification (conversation ID or participant list) is be sent from the VoIP/IM client 106 to the email client 108 in response to the invocation of the first URI, this may be sent in a cryptographically protected form, e.g. in an encrypted form such as a hash of the conversation ID. Furthermore, when the return URI is invoked, the email client 108 may return the conversation identification in the same cryptographically protected form without having decrypted it (or indeed having been able to). The email client 108 does not need to know the conversation ID, and hence the conversation ID can be securely sent to the email client and back again without compromising the ID.

In some embodiments the above-described mechanism also enables the event invite to be distributed to the invitees without the VoIP/IM client 106 knowing their email addresses and without having to disclose their VoIP/IM system usernames to the email client 108, or indeed without the VoIP application disclosing the identities of the individual invitees to the email client 108 at all (which may be desirable for security or privacy reasons). While in embodiments described above the invitees are individually identified in the URI by means of their email addresses, this is not the only possibility. Instead for example, the invitees may be identified only by means of a unique identifier of the conversation (conversation ID), without individual invitees needing to be identified. In this case when the email client 108 receives the conversation ID (in embodiments in hashed form), it submits this conversation ID to the server 116 of the VoIP/IM service (in embodiments still in hashed form). The VoIP/IM service provides a service of mapping conversation IDs to the identities of groups of participants, e.g. their email addresses. Thus in response to receiving the conversation ID, the VoIP/IM service 116 decrypts the ID (if hashed), uses the ID to look up the identities of the participants of that conversation (e.g. their email addresses or another identifier that maps to the email address in the email client's address book), and returns these to the email client 108. The email client 108 is thus able to use the conversation ID to resolve the participants of the conversation. In this sense the email client 108 may be said to be “integrated” with the VoIP/IM service. Based on the resolved IDs, the email client 108 then sends the meeting invite to each of the participants by email (in addition to the .ics file sent via the VoIP/IM conversation).

In general, the URI call is invoked by the VoIP/IM client 106 and so it is not essential to pass information like title, location, individual invitees, time, etc. to the calendar application 108. This information will be returned by the email client 108 to the VoIP/IM client when the event has been created, e.g. in the form of a .ics file. When invoked by the IM client 106 it is only required to supply the unique identifier for the conversation to the email client 108 (or more generally calendar application) in order to resolve the participants that it knows of from the address book. This will be taken care of in the integration between the VoIP client 106 and email client 108.

It will be appreciated that the above embodiments have been described only by way of example.

For instance, the scope of the present disclosure is not limited to a combination of email client application and a VoIP/IM client. As another example, the first application may be a dedicated file-transfer application, or an interactive gaming application. Again these could provide alternative channels through which to disseminate an event invite. And/or, as another example of the second application 108, the second application may be a dedicated calendar application or a social media application having a calendar functionality, and the first application 106 may call on the dedicated calendar application or social media application to create the event invite.

Further, the disclosed mechanism is not limited to being used to create event invites or calendar events. More generally, it can be used for a first application to fetch any assets from a second application, and to disseminate that asset though a conversation conducted by the first application based on a conversation identification sent out from the first application to the second application and returned back from the second application to the first application. For instance, the second application may be a social media application, and the first URI may request that the second application returns a specified item of social media content, such as a particular photograph or video. By means of the return URI and conversation identification, the requested social media content can then be inserted by the first application into the conversation conducted through the VoIP/IM service.

Further, the scope of the present disclosure is not limited to URIs or any specific protocol. Instead the outgoing signal, sent from the first application to the second application in response to invocation of the first URI, could be replaced by the sending of any first outgoing signal including the conversation identification using any suitable inter-process communication (IPC) protocol that is made available on the user's device 102. Similarly, the return signal, sent from the second application back to the first application in response to the invocation of the return URI, could instead be replaced by any return signal returning the conversation identification again using any suitable protocol.

Further, the first and second applications 106, 108 don't necessarily have to be implemented on the same user terminal 102, and instead the first application 106 may be implemented on the first user terminal while the second application 108 may be implemented on a second user terminal of the first user (not shown). E.g. in embodiments, the two terminals may be paired via a local wireless connection such as via a wireless local area network, thus enabling the second application 108 to communicate with the first application 106 to perform the exchanges disclosed herein.

Further, the first and second applications 106, 108 do not necessarily have to be implemented on the user terminal 102 at all. Instead, one or both of these may be hosted on a server and accessed from the first user's terminal 102. For instance, one or both of the first and second applications 106, 108 may be a web-hosted application hosted on a web-server and accessed from a general purpose web browser application run on the first user terminal. E.g. the first application may be hosted on the server of the VoIP/IM provider, and/or the second application may be a social media application hosted on a server of the social media service (not shown). Note also that similar comments may reply in relation to the first and second applications 106′, 108′ run or accessed by the other user terminals 102′.

In some embodiments, the second application 108 may be accessed by the first user terminal 102 as a result of a web fall-back mechanism (e.g. if the first URI uses HTTP or HTTPS). In this case, when the first application 106 invokes the URL of the second application 108 in order to perform a certain specified action, the operating system 104 checks to see if the second application's URL is recognized in its custom list of URIs. If it is, the operating system 104 calls upon the locally installed instance of the second client application 108 to perform the action (e.g. return the calendar invite or social media content). If the locally installed instance is not present however (at least not according to said list), then the operating system 104 calls to a web fall-back experience provided by a web server. The web fall-back experience may be to perform the action from a web-hosted instance of the communication client application, or to download the email client or social media application 108 to the user terminal 102 so that the action can then be performed locally after all.

Further, while the above has been described in terms of communications over the Internet, in alternative embodiments the network 114 may take other forms, such as an intranet within an organization such as a company or university.

Further, note that the term server as used herein refers to a logical entity that may be implemented on one or more physical server units at one or more geographical sites.

Other variants may become apparent to a person skilled in the art once given the disclosure herein. The scope of the present disclosure is not limited by the described embodiments but only by the accompanying claims.

1. A method of interacting between a first application and a second application, the first application being a communication client for using a communication service to conduct a communication session over a network between a group of users comprising a first user and one or more other users, the method comprising:
sending a first signal from the first application to the second application, specifying a request initiated by the first user for a predetermined action to be performed by the second application, said first signal including at least a conversation identification recognized by the first application as identifying the communication session between said group of users;
once the second application has performed said predetermined action, receiving back a second signal at the first application from the second application, the second signal comprising an asset provided by the second application as a result of said predetermined action, or a link to said asset, and further comprising a return of the conversation identification; and
based on the returned conversation identification, providing the asset or the link to the asset to the one or more other users via said communication session conducted through the first application.

2. The method of claim 1, wherein:
the conversation identification is included in the first signal in an encrypted form not decryptable by the second application, and is received back from the second application still in said encrypted form;
the method further comprises the first application decrypting the returned conversation ID; and
the providing of said asset is based on the conversation identification as decrypted by the first application.

3. The method of claim 2, wherein said encrypted form comprises a hash.

4. The method of claim 1, wherein the second application comprises a calendar function, said predetermined action being to create a calendar invite inviting the one or more other users to a calendar event initiated by the first user, and said asset comprising an instance of the calendar invite.

5. The method of claim 4, wherein the calendar event comprises a meeting to be conducted through the communication service used by the first application.

6. The method of claim 4, wherein the second application is an email client.

7. The method of claim 6, wherein the first signal further causes the second application to send an additional instance of the calendar invite to the one or more other users by email, in addition to the providing of the calendar invite through the communication session conducted through the first application.

8. The method of any of claim 7, wherein the second signal further comprises a unique identifier for the calendar event, wherein the instance of the calendar event as provided via the communication session conducted thorough the first application and the instance of said calendar invite as sent by email both comprise the unique identifier, so as not to cause duplication when both received by each of the one or more other users.

9. The method of claim 4, wherein second application is a dedicated calendar application.

10. The method of claim 9, wherein the calendar invite comprises information on the event entered through a user interface of the second application.

11. The method of claim 10, wherein the first signal further comprises an event definition comprising one or more of: a type of the calendar event, a date of the calendar event, a start time for the calendar event, a finish end time for the calendar event, a location for the calendar event, a title of the calendar event, and/or a text description of the calendar event; thereby causing the second application to create said calendar invite based on the event definition sent in the first signal.

12. The method of claim 11, wherein:
the second application is caused to create the calendar event in the form of a .ics file or in a form compliant with RFC5545, the instance of the calendar event received in the second signal being in said form; and
based thereon, said providing via said communication session comprises providing the invitation in the form of a .ics file to the one or more other users via the communication session conducted thorough the first application.

13. The method of claim 1, wherein the second application is social media application for accessing a social media service, said predetermined action being to return social media content from the social media service, and said asset comprising an instance of the social media content.

14. The method of claim 13, wherein the social media content comprises a still or video image.

15. The method of claim 1, wherein the first signal comprises a first URI invoking the second application to perform said predetermined action; and wherein the first URI comprises a second, return URI which when invoked causes the second application to return said asset back to the first application in the second signal.

16. The method of claim 1, wherein the first application is an IM application, the service comprising an IM service and the communication session comprising an IM session.

17. The method of claim 1, wherein the first application is a VoIP application, the service comprising a VoIP service and the communication session comprising a VoIP session.

18. The method of claim 1, wherein said conversation identification comprises either:
a list of said group of users, or
a conversation ID code mapped to the group of users.

19. A computer program product comprising a first application embodied on computer-readable storage and configured so as when run on one or more processors to perform operations comprising:
sending a first signal from the first application to a second application, specifying a request initiated by a first user for a predetermined action to be performed by the second application, said first signal including at least a conversation identification recognized by the first application as identifying the communication session between said group of users;
once the second application has performed said predetermined action, receiving back a second signal at the first application from the second application, the second signal comprising an asset provided by the second application as a result of said predetermined action, or a link to said asset, and further comprising a return of the conversation identification; and
based on the returned conversation identification, providing the asset or the link to the asset to the one or more other users via said communication session conducted through the first application.

20. An apparatus installed with a first application for interfacing with a second application, the first application being a communication client for using a communication service to conduct a communication session over a network between a group of users comprising a first user and one or more other users; wherein the first application is configured so as when run on the to perform operations comprising:
sending a signal from the first application to the second application, specifying a request initiated by the first user for a predetermined action to be performed by the second application, said first signal including at least a conversation identification recognized by the first application as identifying the communication session between said group of users;
once the second application has performed said predetermined action, receiving back a second signal at the first application from the second application, the second signal comprising an asset provided by the second application as a result of said predetermined action, or a link to said asset, and further comprising a return of the conversation identification; and
based on the returned conversation identification, providing the asset or the link to the asset to the one or more other users via said communication session conducted through the first application.
